(19) United States
(12) Patent Application Publication
(10) Pub. No.: US 2016/0339562 A1
(43) Pub. Date: Nov. 24, 2016

(54) ADJUSTABLE HANDLE WORK HOLDING DEVICE

(71) Applicant: Steven Myers, Buffalo Valley, TN (US)

(72) Inventor: Steven Myers, Buffalo Valley, TN (US)

(73) Assignee: JPW INDUSTRIES INC., LaVergne, TN (US)

(21) Appl. No.: 14/718,831

(22) Filed: May 21, 2015

(51) Int. Cl. B25B 1/24; B25B 1/02; B25B 1/06

(52) U.S. Cl. CPC B25B 1/24; B25B 1/06; B25B 1/02

(57) ABSTRACT

In a work holding device, first and second work holding jaws are provided. A force conveying shaft connects between the first and second work holding jaws and is operable to move the first and second work holding jaws relative to one another. A handle connects to the force conveying shaft so that the handle is operable to operate the shaft to move the first and second work holding jaws relative to one another. A handle disengagement apparatus connects between the handle and the force conveying shaft and which is operable in a handle disengage position to disengage the handle from the force conveying shaft so that the handle may be moved without moving the work holding jaws relative to one another. The handle disengagement apparatus also has a handle engage position wherein a movement of the handle from the first position to the second position moves the work holding jaws relative to one another.

### BACKGROUND

In U.S. patent publication 2013-0127104 filed Nov. 21, 2011 titled “Portable Work Holding Device and Assembly” Timothy Onello and Charles Weber, inventors, a portable work holding device such as a vice is disclosed. As shown in prior art FIG. 1 herein, the portable work holding device may, for example, be mounted to a vehicle 11 having a vehicle receiver hitch 12 with a rectangular receiving aperture 13 which receives an elongated rectangular connection member 14. Elongated connection member 14 is attached to a work holding device, such as a vice, having a first work holding jaw 15 and a second work holding jaw 16 drawn together or apart by a force conveying shaft 17 which has a threaded portion 17a engaging in cooperating threads in the second work holding jaw 16. Shaft 17 resides inside of a support tube 8 and between the jaws. By turning handle 18 having a ball 18A at one end, first and second jaws 15 and 16 can be moved towards each other for clamping work pieces.

Although the portable work holding device 10 is shown in a configuration allowing mounting to a vehicle receiver hitch, alternatively the portable work holding device may have its elongated connection member received in other types of mountings such as on a work bench which would receive the elongated connection member 14 in secure fashion.

When attached to the vehicle 11, the handle 18 may be in the downward position. In this regard it is noted that the handle 18 is rigidly fastened at an end opposite the ball 18A to a handle connection apparatus 19 for turning the force conveying shaft 17. When the vehicle is in motion such as at a work site or driving down a road, there is a danger that the handle 18 might inadvertently be struck by objects on the ground beneath the vehicle. Therefore with the prior art device shown in FIG. 1 it was preferable to align the handle in the upper position as shown in dashed lines at 18′. Additionally, even if the portable work holding device is not connected to a vehicle or the vehicle is not in motion, it may be desirable to rotate the handle to different positions without moving the work jaws. However with the prior art device shown in FIG. 1 whenever the handle is moved in a rotational direction, the first and second work holding jaws 15 or 16 move relative to each other. This can be a disadvantage.

### SUMMARY

It is an object to provide a work holding device, and more particularly a portable work holding device, wherein the handle can be moved in a rotational arc but the jaws of the device do not move relative to each other.

In a work holding device, first and second work holding jaws are provided. A force conveying shaft connects between the first and second work holding jaws and is operable to move the first and second work holding jaws relative to one another. A handle connects to the force conveying shaft so that the handle is operable to operate the shaft to move the first and second work holding jaws relative to one another. A handle disengagement apparatus connects between the handle and the force conveying shaft and which is operable in a handle disengage position to disengage the handle from the force conveying shaft so that the handle may be moved without moving the work holding jaws relative to one another. The handle disengagement apparatus also has a handle engage position wherein a movement of the handle from the first position to the second position moves the work holding jaws relative to one another.

### BRIEF DESCRIPTION OF THE DRAWINGS

FIG. 1 is a perspective view of a prior art portable work holding device mounted to a vehicle receiver hitch of a vehicle;

FIG. 2 is an exploded perspective view of an exemplary embodiment a handle disengagement apparatus used to improve a work holding device of the general type shown in prior art FIG. 1;

FIG. 3A is a perspective cutaway view of the handle disengagement apparatus shown in FIG. 2 with the handle disengagement apparatus in a handle engage position;

FIG. 3B is a cross sectional view and taken along line 3B-3B in FIG. 3A; and

FIG. 4 is a perspective cutaway view of the handle disengagement apparatus shown in FIG. 3A but in a handle engage position.

### DESCRIPTION OF EXEMPLARY EMBODIMENTS

For the purposes of promoting an understanding of the principles of the invention, reference will now be made to the preferred exemplary embodiments/best mode illustrated in the drawings and specific language will be used to describe the same. It will nevertheless be understood that no limitation of the scope of the invention is thereby intended, and such alterations and further modifications in the illustrated embodiments and such further applications of the principles of the invention as illustrated as would normally occur to one skilled in the art to which the invention relates are included herein.

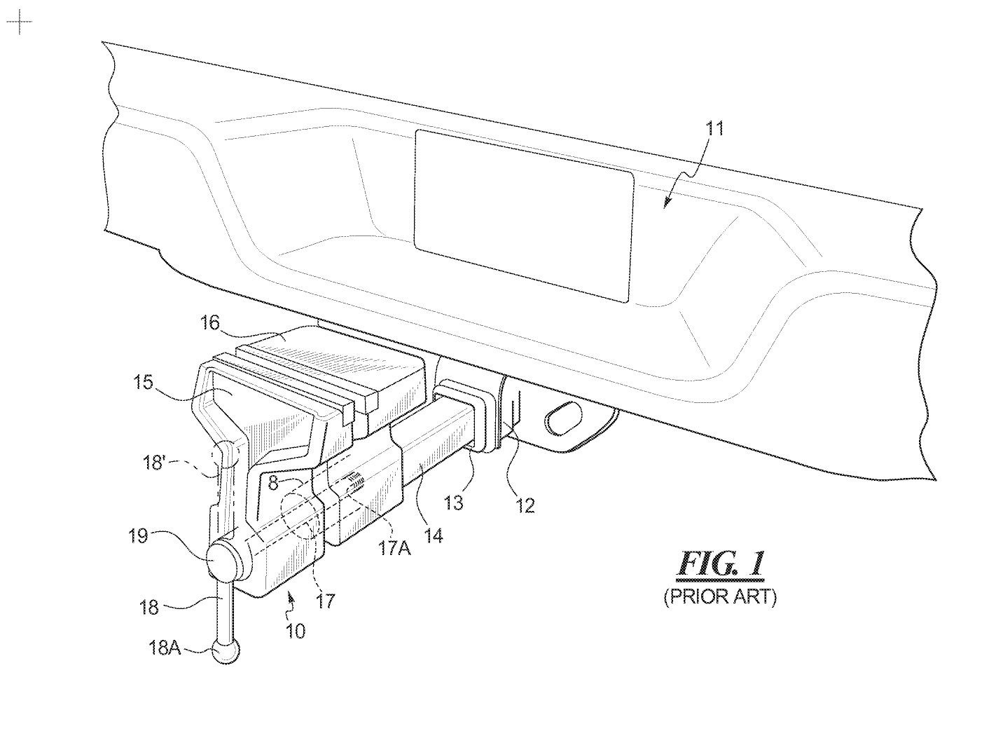

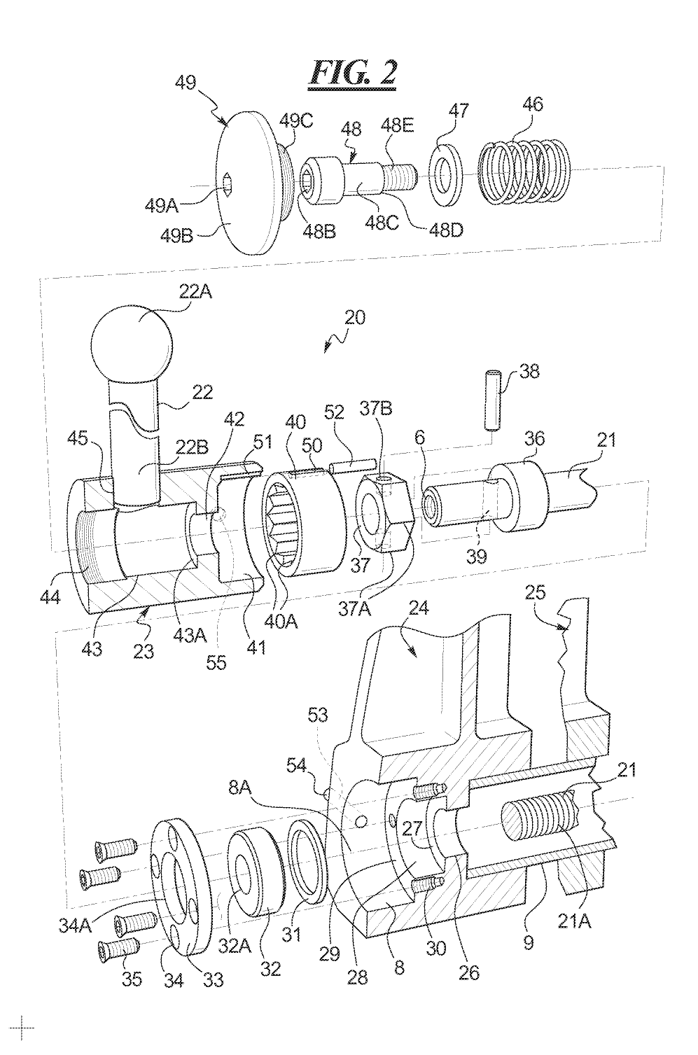

FIG. 2 illustrates an exploded perspective and partial cross sectional view of an exemplary embodiment of a handle disengagement apparatus adapted to improve operation of the prior art work holding device shown in FIG. 1. In FIG. 2 first and second work holding jaws 24 and 25 are partially illustrated and are drawn together and spread apart in a fashion similar to the prior art work holding device of FIG. 1 by use of a force conveying shaft 21 inside a support tube 9 and having threads 21A engageable with the second work holding jaw 25.

The handle disengagement apparatus 20 will now be described in detail with respect to FIG. 2. The force conveying shaft 21 with threaded portion 21A is received through a shaft passage 26 in the first work holding jaw 24 after it passes through the hollow support tube 9. An inner shoulder 27 surrounding the shaft passage 26 is provided which receives a washer 31 surrounding the shaft 21 and functions as a stop surface relative to the washer 31. Thereafter a bushing 32 follows the washer 31 surrounding the shaft 21. Then a shaft retainer ring 33 is provided having apertures 34 and which is bolted to an outer shoulder 29 at an end of pocket 8 by retention screws 35 received in a corresponding threaded holes 30. If desired a set screw 54 received in threaded aperture 53 in a sidewall of pocket 8 is provided which is engageable with a notch 55 in an outside surface of housing 23. The setscrew 54 is used to lock the handle 22A in a vertical position if desired.

As shown in the middle section of FIG. 2, a stop ring 36 is secured to the shaft 21 which rests against the bushing 32. The shaft 21 passes through an aperture 34A of the retainer ring 33 and then through an aperture 32A of the bushing 32. A hex nut 37 having an inner aperture 37C is received over the shaft 21 and locked in place by use of a lock pin 38 received in a lock pin receiving aperture 39. Pin 38 also passes through an aperture 37B in the hex nut 37. Hex nut 37 has a plurality of engagement corner surfaces 37A. These engagement corner surfaces 37A are engageable with cooperating V-shaped engagement groove surfaces 40A of a socket 40 which is slideable over the hex nut 37 when the engagement surfaces 40A are aligned with engagement surfaces 37B of the hex nut 37. Socket 40 is locked in socket cavity 41 by a locking pin 52 received in half-circle cutout 50 in socket 40 and half-circle cutout 51 in socket cavity 41.

The socket 40 is received in the socket cavity 41 in a housing 23. The shaft 21 then passes through a shaft passage 42 into a spring receiving cavity 43 where it passes through a spring 46. Threads 44 are provided at one end of the receiving cavity 43 for mating with a threaded section 49C of a cap 49 described hereafter.

A handle 22 with a handle ball 22A at one end has a mounting portion 22B received in a handle mounting aperture 45 in press fit fashion.

As shown in the upper portion of FIG. 2, with the spring 46 surrounding the shaft 21, one end of the spring 46 abuts against a spring abutment shoulder 43A. The opposite end of the spring abuts against a washer 47 received on a smooth shaft portion 48C of bolt 48. Bolt 48 has a bolt head 48A and a hex drive receiving aperture 48B. Opposite the drive aperture 48B is a threaded portion 48E which is threaded into a threaded bolt receiving aperture 6. The threaded portion 48E of the bolt 48 is threaded tightly into the aperture 6 until the shoulder 48D on the bolt 48 engages with an opening end of the aperture 6 at the end of the shaft 21.

The cap 49 has an aperture 49A shaped for receiving a hex drive tool received in the hex drive aperture 48B of the bolt 48. The outer surface of the cap 49 has formed by a convex surface 49B.

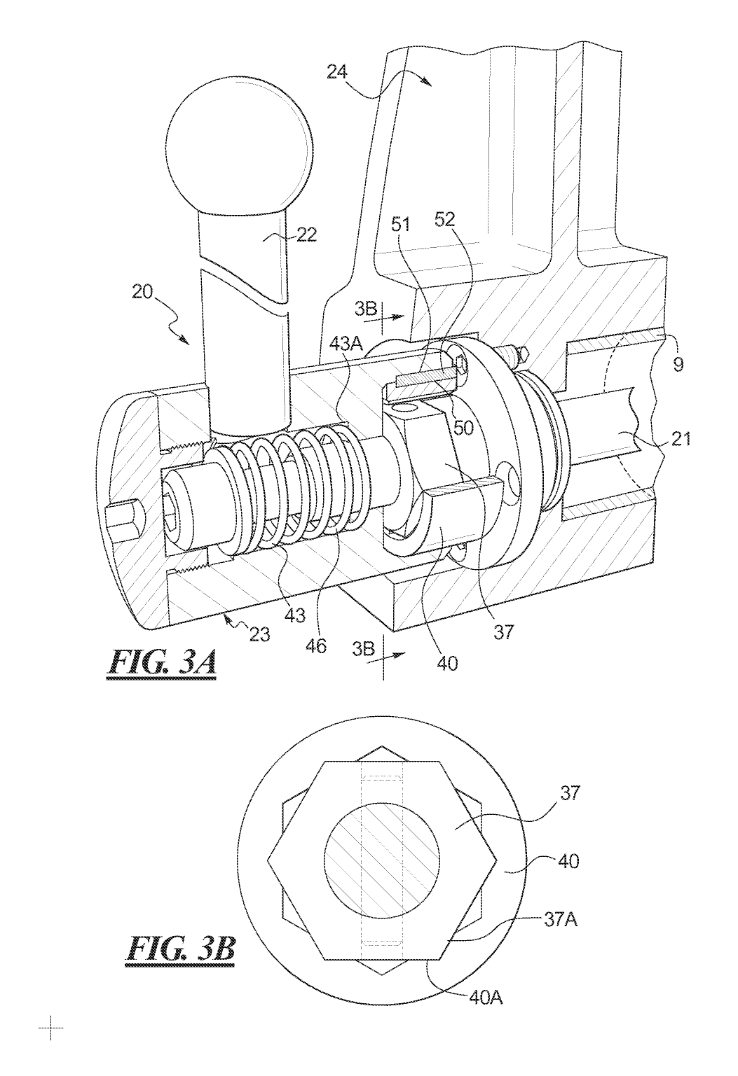

In FIG. 3A the handle disengagement apparatus is illustrated with the handle in a handle engage position wherein the hex nut 37 is slid inside of the socket 40 with respective engagement services engaged. Thus if the handle 22 is rotated the first and second jaws of the holding device will move either towards or away from each other. FIG. 3B shows a cross sectional end view illustrating the hex nut 37 received within every other V-shaped engagement surface of the socket 40.

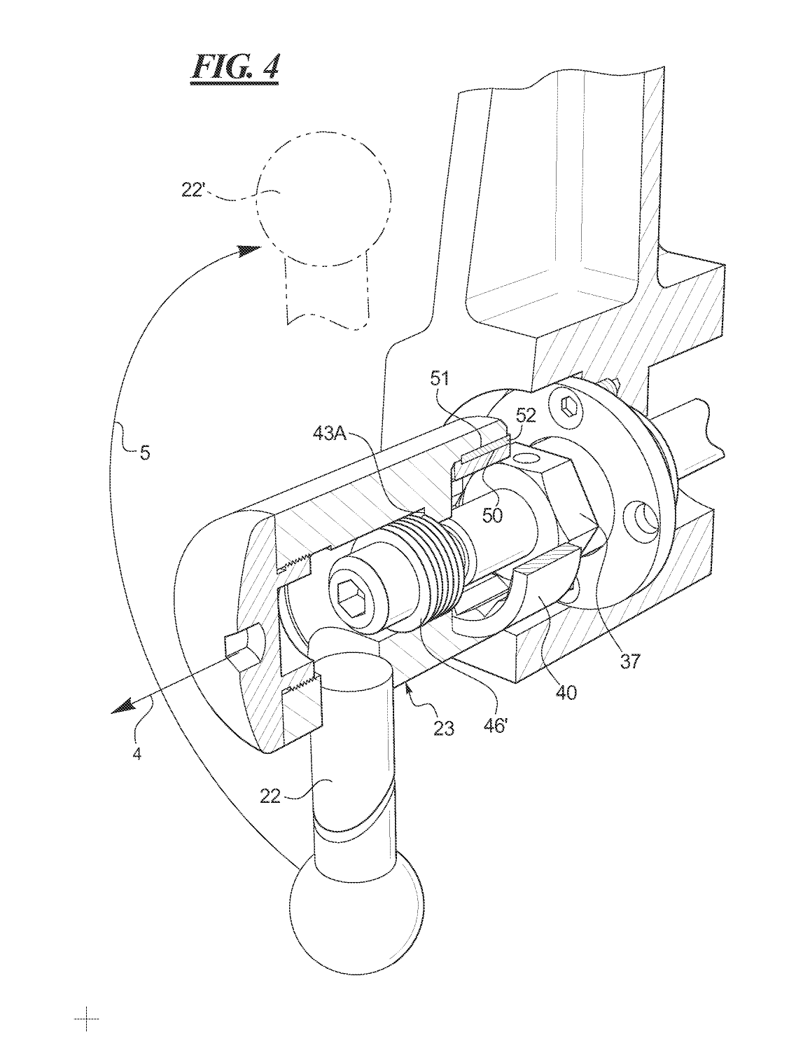

FIG. 4 shows the handle disengagement apparatus with the handle in a handle disengage position wherein the spring is shown at 46′ in a compressed configuration. Here the operator has pulled outwardly on the handle 22 in the direction 4 allowing rotation of the handle 22 around the arc 5 such as to an upper position indicated at 22B in dashed lines. In this position the handle is in a safe mode so that the handle will not accidentally engage with other objects beneath the work holding device such as if the vehicle is in motion at a work site or over a road.

It should further be appreciated that the handle disengagement apparatus may be used on any work holding device whether or not that work holding device is portable or whether or not that work holding device is attached to a vehicle as shown in prior art FIG. 1. The handle disengagement apparatus is thus not only useful to move the handle into a protective position, but is also useful to move into a different position as desired by an operator of the work holding device when the work holding device jaws are completely closed, when work holding device jaws are separated and holding a component in a vice grip fashion, or even if the work holding jaws are separated and not holding a part. Thus the operator can conveniently move the handle without moving the jaws.

Although preferred exemplary embodiments are shown and described in detail in the drawings and in the preceding specification, they should be viewed as purely exemplary and not as limiting the invention. It is noted that only preferred exemplary embodiments are shown and described, and all variations and modifications that presently or in the future lie within the protective scope of the invention should be protected.

We claim as our invention:

1. A work holding device, comprising:
first and second work holding jaws;
a force conveying shaft connected between the first and second work holding jaws, the force conveying shaft being operable to move the first and second work holding jaws relative to one another;
a handle connected to the force conveying shaft, the handle being operable to operate the force conveying shaft so as to move the first and second work holding jaws relative to one another; and
a handle disengagement apparatus connected between the handle and the force conveying shaft, the handle disengagement apparatus being operable in a handle disengage position to disengage the handle from the force conveying shaft so that the handle may be moved from a first position to a second position without moving the first and second work holding jaws relative to one another, the handle disengagement apparatus having a handle engage position wherein movement of the handle from the first position to the second position moves the first and second work holding jaws relative to one another.

2. The work holding device of claim 1 wherein the handle disengagement apparatus has a nut mounted to the force conveying shaft with engagement surfaces, said nut engagement surfaces being receivable into a socket having corresponding engagement surfaces.

3. The work holding device of claim 2 wherein a locking pin is received in a recess in an outer surface of the socket and also in a recess in an inner surface of a socket cavity in a housing of the handle which locks the socket to the handle housing.

4. The work holding device of claim 3 wherein a pocket in the first work holding jaw which receives an end of said handle housing has an aperture with a setscrew, and wherein said handle housing has in an outer surface a notch engageable by an end of the setscrew to lock the handle such that the handle is in a vertical position.

5. The work holding device of claim 2 wherein the nut comprises a hex nut and the socket has a plurality of V-shaped grooves engageable with corners of the hex nut.

6. The work holding device as claimed in claim 1 wherein the force conveying shaft includes a threaded portion.

7. The work holding device as claimed in claim 1 wherein the handle disengagement apparatus has associated therewith a plurality of first engagement surfaces, wherein the force conveying shaft has associated therewith a plurality of second engagement surfaces, the first and second engagement surfaces being disposed in cooperative engagement with one another when the handle is in the engage position.

8. The work holding device as claimed in claim 7 wherein the first and second engagement surfaces are slidably disposed relative to one another for movement between the handle engage position and the handle disengage position.

9. The work holding device as claimed in claim 1 wherein the handle disengagement apparatus includes a spring surrounding the force conveying shaft so as to exert a biasing force to urge the handle to the engage position, the spring being mounted so that a user overcomes the biasing force to move the handle to the disengage position.

10. The work holding device of claim 1 wherein the work holding device as a support shaft receivable in a mounting aperture facilitating the work holding device being portable.

11. The work holding device of claim 10 wherein the support shaft is rectangular and is adapted for being received within a rectangular vehicle receiver hitch on a vehicle.

12. A work holding device, comprising:
first and second work holding jaws;
a force conveying shaft connected between the first and second work holding jaws, the force conveying shaft being operable to move the first and second work holding jaws relative to one another;
a handle connected to the force conveying shaft, the handle being operable to operate the force conveying shaft so as to move the first and second work holding jaws relative to one another; and
a handle disengagement apparatus connected between the handle and the force conveying shaft, the handle disengagement apparatus being operable in a handle disengage position to disengage the handle from the force conveying shaft so that the handle may be moved from a first position to a second position without moving the first and second work holding jaws relative to one another, the handle disengagement apparatus having a handle engage position wherein movement of the handle from the first position to the second position moves the first and second work holding jaws relative to one another, and wherein a socket with V-shaped grooves cooperates with a hex nut having corners, in said engage position the corners of the hex nut resides in corresponding V-shaped grooves of the socket, and in the disengage position the nut is separated from the socket.
